(19) United States
(12) Patent Application Publication
(10) Pub. No.: US 2006/0000215 A1
(43) Pub. Date: Jan. 5, 2006

(54) ENCAPSULATED RADIOMETRIC ENGINE

(76) Inventors: Stanley H. Kremen, East Brunswick, NJ (US); Marco Scandurra, Cambridge, MA (US)

Correspondence Address: STANLEY H. KREMEN, 4 LENAPE LANE, EAST BRUNSWICK, NJ, 08816, US

(21) Appl. No.: 11/160,515

(22) Filed: Jun. 27, 2005

Related U.S. Application Data
(63) Continuation-in-part of application No. 11/068,470, filed on Feb. 22, 2005.
(60) Provisional application No. 60/521,774, filed on Jul. 1, 2004.

(51) Int. Cl. F03G 7/00

(52) U.S. Cl. 60/721

(57) ABSTRACT

A light and efficient engine for air vehicles, ground vehicles, boats, ships, and submarines. The engine operates in a closed and controlled gas environment according to the radiometric principles. It comprises a multiplicity of specially fabricated modules used as vanes for large torque generation upon application of temperature gradients. High efficiency heat pumps are used to maintain the temperature gradients. The engine is quiet, does not burn hydrocarbon fuels, and is more resistant, efficient, and compact than previously proposed radiometric devices. The engine can be used in vehicles completely immerged in liquids.

### CROSS REFERENCE TO RELATED APPLICATIONS

This nonprovisional patent application is a continuation-in-part (CIP) of U.S. patent application No. 11/068,470 filed on Feb. 22, 2005, said application being a US National Stage Entry under 35 U.S.C. § 371 of International PCT Application Number PCT/US 05/02820 filed on Jan. 31, 2005, which, in turn, is the US Nonprovisional counterpart of U.S. Provisional Applications No. 60/481,999 filed on Feb. 2, 2004 and 60/521,774 filed on Jul. 1, 2004. The Present application claims the benefit of and priority to the PCT Application, to its US National Stage Entry, and to both Provisional Applications. The PCT Application along with its US National Stage Entry and both Provisional Applications are incorporated by reference herein in their entirety hereto. These prior applications will hereinafter be referred to herein as the Priority Patent Applications.

### ANALYSIS OF THE PROBLEM AND THE PRIOR ART

Modern vehicle engines rely on hydrocarbon combustion. These engines expel hot gases like carbon monoxide and carbon dioxide into the air, thus contributing to atmospheric pollution and global climate change through the greenhouse effect. Fossil fuel combustion engines also cause considerable acoustic pollution. In urban environments, high-noise levels due to vehicle engines represent a problem not only from congested ground traffic but especially from aircraft operation near city-airports. Aircraft gas-turbines are among the noisiest devices invented by man. Boat and submarine engines also produce acoustic disturbances that have been linked by recent university studies to the depletion of marine mammal populations.

Electric engines represent an environmentally acceptable alternative. However, existing electric engines are bulky devices requiring long copper coils and heavy magnets. These engines have a low thrust-to-weight ratio, and are unsuitable for aircraft propulsion.

In the Priority Patent Applications, an electric propulsion system entitled Radiometric Propulsion System was proposed. That invention addresses and overcomes some of the disadvantages of conventional electric engines. It uses the physical principle that drives the Crookes Radiometer, a device well known to the art and shown in FIG. 1. This device comprises a partially evacuated bulb chamber 1, a pivot 2, and a four winged mill 3 mounted on pivot 2. Each wing or vane is lamp-blacked on one side 4, and silvered on the other side 5. When intense light impinges on the vanes, the mill spins due to a radiometric force. The motion is completely silent.

The action of the radiometric force is roughly described as follows. The black surface 4 of each vane becomes hotter than the silvered surface 5 due to their different absorption coefficients. This temperature difference generates a force directed toward the cooler silver surface as residual air molecules contained in the vessel impinge upon the vanes. This is due to air molecules at low density exerting different pressures on hot and on cold bodies. However, the force driving the radiometer is small, of the order of 10⁻⁶ N. Furthermore, at atmospheric pressure the effect vanishes.

The Priority Patent Applications teach that the radiometric force can be greatly enhanced so as to be significant even at atmospheric pressure by perforating each individual vane of the radiometer with a compact array of apertures as shown in FIG. 2. This is a top plan view of the lamp-blacked surface 4 of vane 6. The vane has a multiplicity of apertures 7. The apertures can have any kind of shape and any kind of matrix arrangement. For example, they can have a rectangular, hexagonal or unordered matrix arrangement. The theory or radiometric forces, delineated in the book by L. Loeb “Kinetic Theory of Gases” 1961, predicts that the forces are maximized when the average distance between the apertures is of the order of λ, where λ is the mean free path of air molecules. The thickness of the vane must also be of the order of λ. At atmospheric pressure, λ is approximately 70 nm. Therefore, the enhancement of radiometric forces must be accomplished with the help of modern nano-engineering technology. The Priority Patent Applications propose to use a large, perforated radiometric vane or plate as an independent propulsion system capable of providing linear thrust to a vehicle. No rotary motion is disclosed in those applications. The thrust is generated by applying a temperature difference at the two surfaces of the plate which are separated by an insulator. The temperature difference is maintained by means of efficient thermoelectric heat pumps integrated in the plate. The plate is anchored to a vehicle and exposed in the open environment much like a sail.

The Priority Patent Applications teach that this propulsion system can be very efficient, quiet and light. However, several problems are associated with this configuration. The radiometric plate is exposed to environmental stresses, including wind, corrosion, and oxidation. Small dust particles and moisture droplets can clog the sub-micron apertures of the plate thereby reducing the efficiency of the device. Furthermore, that propulsion system may not be suitable for operation in liquids. In particular, application in submarine vehicles is unlikely. Liquids are non-compressible fluids for which the mean free path is not well-defined. Instead the interaction potentials between molecules are the relevant physical variable. Therefore the basic principles driving the Crookes Radiometer are not expected to be valid in liquids. In addition, problems caused by corrosion of the radiometric plate due to sea salt, mineral and organic depositions as well as the difficulty of operating thermoelectric devices in water mandates that another approach be sought for use with submarines.

With respect to surface vehicles such as automobiles, the radiometric propulsion system proposed in the Priority Patent Applications requires that large-surface, sail-like plates be mounted, for instance, on the roof of a car. Such sails would lift the center of mass of the vehicle, thereby compromising the overall aerodynamic efficiency. It could cause the vehicle to overturn due to high wind velocities. The increased height of the vehicle would prevent it from accessing low clearance underpasses, driveways, garages, and parking lots.

It would be desirable to produce an electric engine having the same performance efficiency of the radiometric propulsion system, but in a more compact configuration and in a more discrete appearance. It would also be desirable to produce a radiometric engine that is embedded in a protected environment, where exposure to humidity, wind and dust can be controlled. Finally, it would be highly desirable to produce a radiometric engine that can be safely and efficiently be employed in submarines.

### BRIEF DESCRIPTION OF THE DRAWINGS

FIG. 1 shows a Crookes Radiometer, a device known to the art.

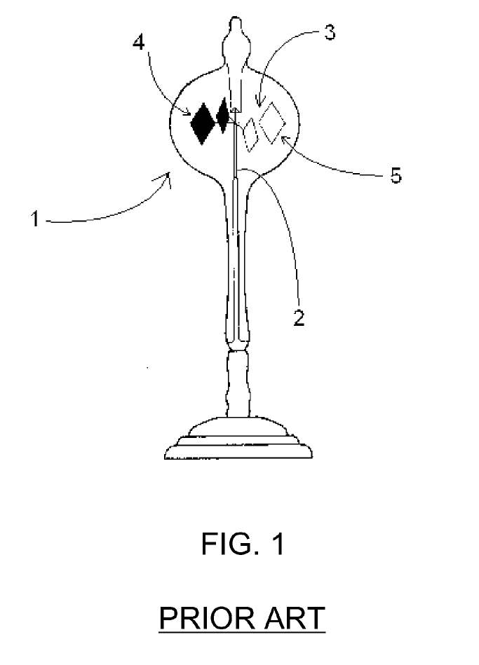

FIG. 2 is a top view of an improved radiometric vane or plate.

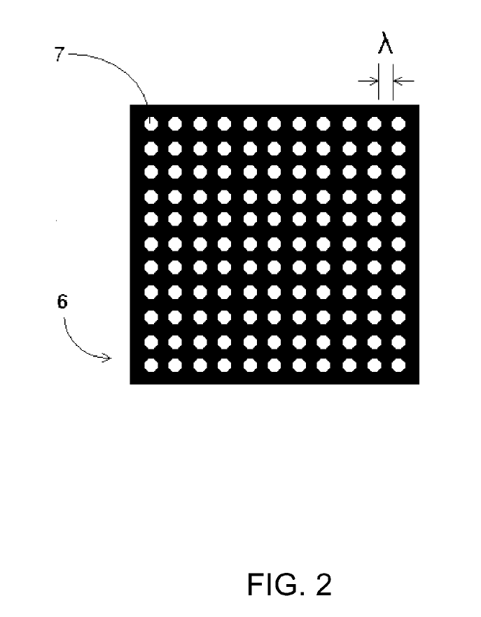

FIG. 3 is a front view of a radiometric thruster. A device comprising a radiometric plate and two thermoelectric Peltier couples.

FIG. 4 is a top view of the thruster showed in FIG. 3

FIG. 5 is a side view from left of the above mentioned thruster.

FIG. 6 is a front view of a complete encapsulated radiometric engine comprising a vessel a shaft, vanes, a power supply and a propulsion apparatus for the first embodiment.

FIG. 7 shows a detail of the first embodiment, where the radiometric modules are integrated with thermoelectric Peltier couples.

FIG. 8 shows a detail of the second embodiment, where the radiometric modules are integrated with generic electric coolers like thermionic/thermotunneling coolers.

FIG. 9 is a partial detailed view of an encapsulated radiometric engine featuring reinforced modules for the third embodiment.

FIG. 10 shows a schematic view of the fourth embodiment of the encapsulated engine having aerodynamically shaped radiometric vanes rather than flat vanes.

FIG. 11 shows a cross-sectional view of an aerodynamically shaped vane and streamlines of air flow.

FIG. 12 shows the detail of the radiometric module with coolers of the aerodynamically shaped vane.

FIG. 13 shows a cross-sectional view of a step-shaped radiometric module of the fifth embodiment.

### DETAILED DESCRIPTION OF THE INVENTION

The Present Invention proposes a radiometric engine which uses the principles driving a Crookes radiometer. The advantages include efficiency, zero pollutant emissions, quiet operation, and high thrust-to-weight ratio. This engine will not be prone to perturbation due to external environmental conditions such as wind, dust, corrosion, and rain. The Present Invention uses the configuration of a rotating mill enclosed in a vessel, as in Crookes original device. By contrast, the torque provided by rotation of the mill in Crookes device is insufficient for most practical applications. However, in the present invention, the mill provides much higher torque to a shaft which, in turn, can impart rotation directly, or by means of transmission gears, to the wheels of an automobile, or the propellers of an aircraft, boat, submarine, or any other device that uses rotational motion. In the Present Invention, a multiplicity of improved, radiometric vanes is used. Thus the number of vanes contributing to the torque can be much larger than the 4 vanes present in Crookes original Radiometer. The vanes of the Present Invention comprise an insulator sandwiched between the hot and the cold surfaces. These surfaces will be hereinafter referred to as the radiometric membranes.

In one embodiment of the vane, a gaseous insulator is sandwiched between two perforated radiometric membranes to increase thermal insulation. The gas can be the naturally occurring gas that fills the vessel. Thus, a radiometric vane appears as two parallel perforated membranes separated by a small gap.

In another embodiment, the temperature difference between the two membranes is maintained by means of one or more electric heat pumps. Thermoelectric, micro-coolers integrated in the vanes can serve this purpose. Other electric devices including thermomagnetic and thermionic coolers can also be used. All kinds of coolers described in the Priority Patent Applications may be used here. In particular, Peltier coolers based on low-dimensional materials such as superlattices, nano-composites, nano-wires, and nano-dots, or materials based on skutterudites are usable in this invention. The implementation of integrated micro-coolers reduces the thermal paths from the membranes to the coolers, thereby reducing the impact of parasitic temperature differences inherently present when using heat pumps. Several configurations for integrated micro-coolers are disclosed in the various embodiments of the Priority Patent Applications. All of them can be implemented in the present invention.

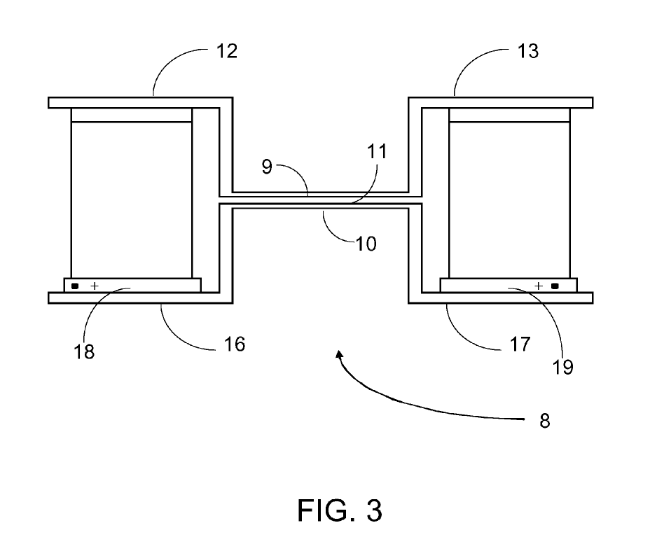

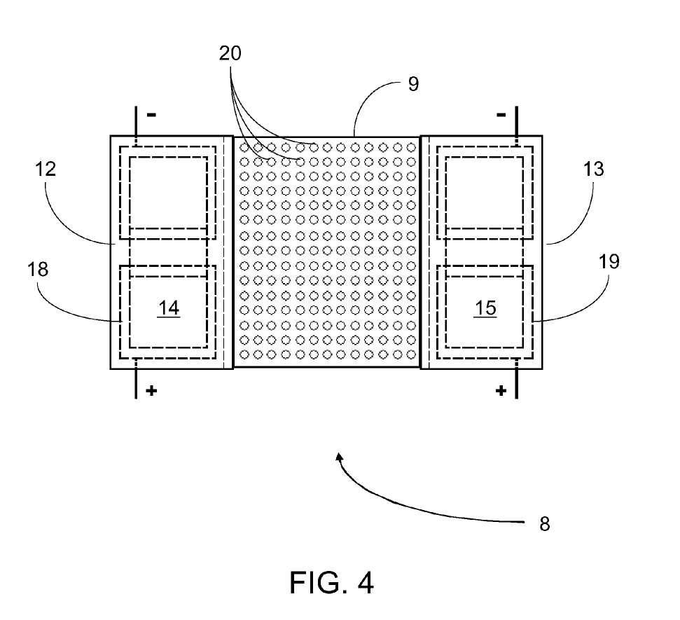

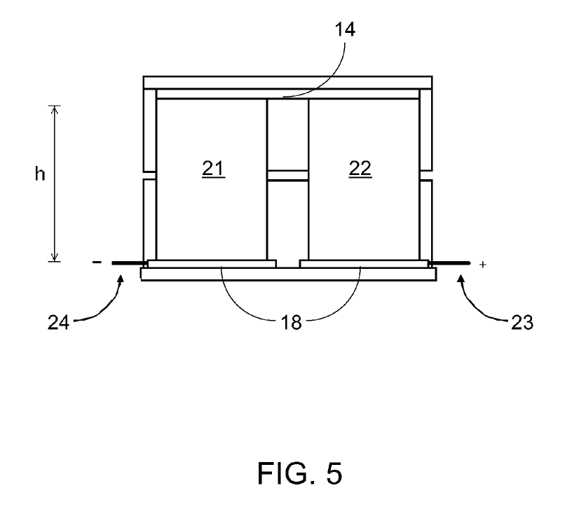

An exemplary configuration is shown in FIGS. 3, 4, and 5. FIG. 3 is the front elevational view of a radiometric thruster 8. FIG. 4 is a top plan view of the thruster. FIG. 5 is a left side elevational view of the thruster. A thruster is the smallest independent element of the radiometric vane disclosed in the present invention. The thruster 8 comprises two perforated membranes 9 and 10 separated by an insulator 11 which can be a gas. Membrane 9 is connected thermally by means of L-shaped plates 12 and 13 to junctions 14 and 15 of two Peltier couples. Membrane 10 is connected thermally by means of L-shaped plates 16 and 17 to junctions 18 and 19 of said couples. When voltage is applied to the Peltier couples, or thermoelectric coolers, the thruster generates a propulsive force. If the membrane 9 is cold and membrane 10 is hot, the thruster 8 generates force directed from the hot membrane towards the cold membrane. A detailed description of the thruster is also given in the Priority Patent Applications. The thrust generated by this device per unit surface of the membranes is given by the formula:

$$P = ( \frac{1}{2} + \frac{3}{4 π} ) {nk}_{B} ( {T}_{h} - {T}_{c} )$$

Where Tₕ and T_{c} are the temperatures of the hot and cold membranes respectively, n is the number of gas molecules per unit volume, and k_{B} is the Boltzmann constant. This equation is valid for membranes with hole diameter equal to the mean free path λ and with a 50% open area (also known as porosity).

FIG. 4 is a top plan view of membrane 9 of the thruster 8 with holes 20. FIG. 5 shows the two legs 21 and 22, the height of each being h, and the junctions 14 and 18 of the left Peltier couple. Voltage is supplied to the couple by means of electrical contacts 23 and 24.

Several thrusters can be connected in series electrically and in parallel thermally to form large surface vanes used to generate torque and rotary motion in the Present Inventions. The series electrical connection is done in this manner so that the same current would flow through each Peltier couple. The parallel thermal connection is done in this manner in order to keep all of the hot membranes at the same temperature Tₕ and all of the cold membranes at the same cold temperature T_{c}. This is the preferred connection, but the Present Invention does exclude other types of electrical or thermal connection. A vane comprising several thrusters will be hereinafter called a module. The physical and geometric features of the modules of the Present Invention are the same as that of the radiometric modules described in the Priority Patent Applications.

In the Present Invention, an encapsulated radiometric engine, the vanes as well as the pivot or shaft are encapsulated in a suitable vessel which is sealed. The engine vessel contains a gas with controlled pressure, humidity, and dust density. These parameters are tuned as to maximize the efficiency, the stability, and the life of the device. The engine is preferably powered by an electric power source as a battery, fuel cells, power grids, etc.

### THE PREFERRED AND ALTERNATE EMBODIMENTS

### First Embodiment

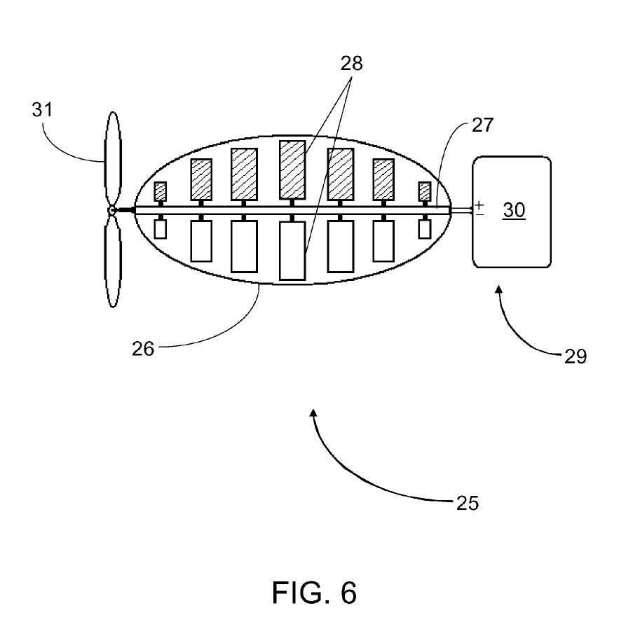

FIG. 6 shows a front elevational view of the first embodiment, an encapsulated engine 25. A sealed vessel 26 contains a hollow shaft 27 to which a plurality of radiometric modules 28 is attached. A module may comprise one or more radiometric thrusters similar or identical to the radiometric thrusters described in the Priority Patent Applications. In FIG. 6, the radiometric modules are oriented so that the cold side of a module couples to the hot side of the opposite module attached symmetrically with respect to the shaft 27. Therefore, each pair of symmetric modules exerts a torque on the shaft. The temperature difference between the hot and cold sides of the modules is maintained by means of thermoelectric micro-coolers integrated with the radiometric plate within each module. The coolers are part of a global electric circuit 29 which comprises a DC power source 30. This can be, for example, a high capacity battery or a package of fuel cell stacks. The circuit wires run inside the shaft and deliver voltage to each individual module. When the circuit is closed, an electromotive force is applied to the coolers and a temperature gradient is established. The modules impart a torque to the shaft, which in turn imparts a rotary motion to the propulsion apparatus represented ideally in the drawing by element 31. The propulsion apparatus can be the propeller of an airplane, a boat, a ship, or a submarine. However it can also be the wheel of a ground vehicle such as an automobile or truck. An encapsulated engine of this kind can be connected to each independent wheel or propeller of a vehicle. The motion of the plurality of engines can be synchronized by a computer. Alternatively, a central hub-engine can provide motion to all the wheels or propellers of a vehicle simultaneously by means of transmission gears, much the same as in a currently available vehicle.

In FIG. 6, the vessel 26 is made of a strong material, which is not necessarily optically transparent. The gas contained in the vessel 26—unlike the gas contained in Crookes Radiometer—does not need to be rarefied. The theory of enhanced radiometric forces predicts that the enhanced force is linearly proportional to the gas density n provided that the diameter of the holes remains of the order of λ. The interior of the vessel can be maintained at standard atmospheric pressure. However, the pressure inside the vessel may be greater than this. Large pressures of several atmospheres can be achieved, thereby enhancing the force to a degree not achievable by the open air radiometric propulsion systems disclosed in the Priority Patent Applications. To prevent the mean free path from shrinking below the capabilities of nano-technology, the vessel can be filled with a gas that has a typical mean free path larger than the mean free path of air (e.g., helium). The possibility of implementing high pressure, low mean free path gases as a working fluid, is a remarkable advantage of the encapsulated engine with respect to the open air propulsion system.

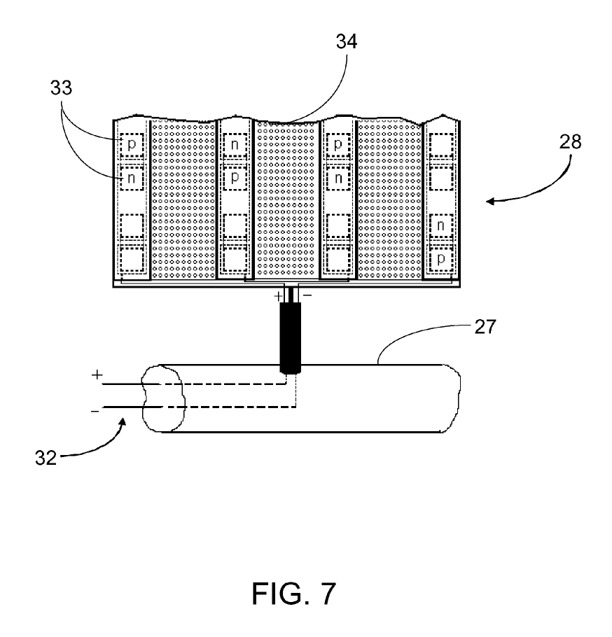

A detailed representation of a module within this embodiment is given in FIG. 7. This is a partial top plan view of one module 28 mounted on the shaft 27. Part of the electrical circuit 32 is visible as well. The module 28 comprises a series of thermoelectric Peltier couples 33 mounted in series electrically and in parallel thermally. Each couple comprises two legs and two junctions. The legs are made of material with a high Seebeck coefficient, low thermal conductivity and high electrical conductivity. Superlattices, nano-composites, nano-wire and nano-dot based materials, as well as skutterudites can be implemented for leg fabrication. The junctions are made of a good electrical and thermal conductor such as metals. The perforated radiometric membranes 34 (only one membrane is visible) are made of radiometric material, i.e., a material with high Young's Modulus, low electrical conductivity and high thermal conductivity. The membranes may be fabricated from a material such as SiC, AlN, diamond like carbon, or tungsten. Should tungsten be selected, a thin layer of electrically insulating material (e.g., SiO₂) must be sandwiched between the junction and the L-shaped plates to prevent an electrical short circuit. Nano-perforation can be accomplished using a number of techniques such us interference lithography, alumina template lithography or block copolymer lithography.

### Second Embodiment

The second embodiment features an encapsulated engine similar to the one shown in FIG. 7. However the method for maintaining the temperature gradient is different from thermoelectric technology. This embodiment uses generic electric micro-coolers.

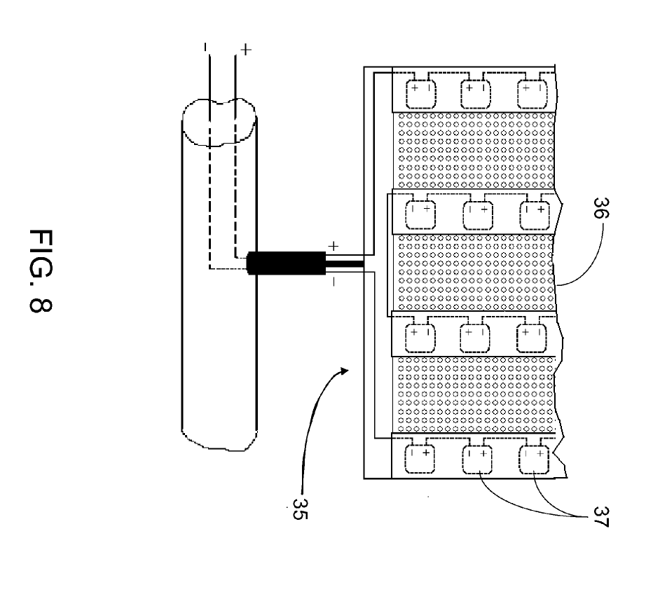

FIG. 8 shows a detailed partial view of one module 35. This module comprises a perforated radiometric plate 36 and a multiplicity of generic coolers 37 connected in series electrically and in parallel thermally. The coolers 37 can exploit any physical principle to achieve high efficiency heat pumping. In particular thermionic and/or thermotunneling micro-coolers may be used.

### Third Embodiment

This embodiment is an encapsulated radiometric engine similar to the one shown in the first and second embodiments. The third embodiment features reinforced radiometric modules instead of simple modules. Reinforced modules can have a larger surface than simple modules as disclosed in the Priority Patent Applications.

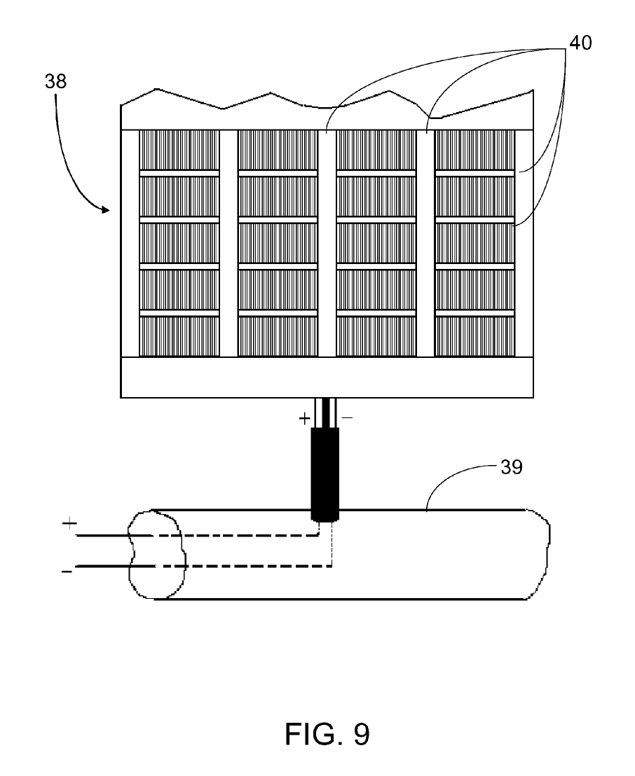

FIG. 9 shows a partial view of this embodiment. Here, a reinforced radiometric module 38 is anchored to a shaft 39 inside a radiometric vessel. The module 38 has crossing beams or struts 40 which reinforce the plate+coolers structure. The technique was taught in the Priority Patent Applications. The holes and the coolers are not visible in this figure.

A reinforced module can employ thermoelectric Peltier coolers, thermionic/thermotunneling coolers, or generic coolers.

### Fourth Embodiment

FIG. 7 shows an encapsulated radiometric engine having a plurality of radiometric vanes that are flat plates. The entire vane in this first embodiment is radiometrically active thereby producing a large radiometric force. However, as the shaft spins, the vanes meet with considerable wind resistance.

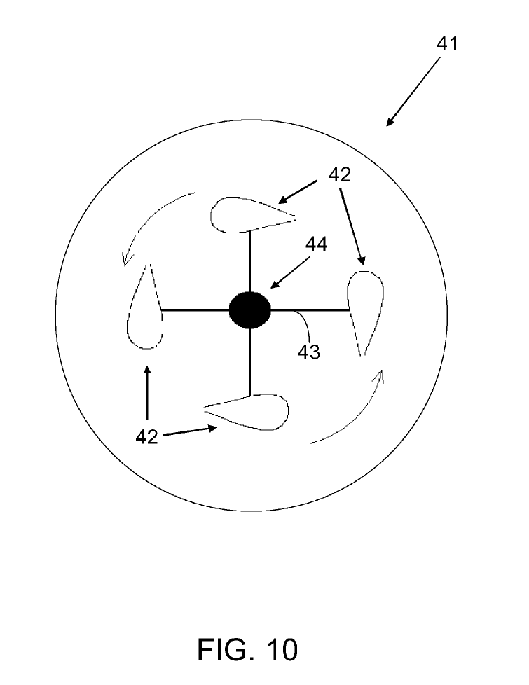

The fourth embodiment is different in that the vanes are aerodynamically shaped. Not only does the curved shape of the vanes reduce the air drag, but the vanes also inherently produce a jet effect thereby enhancing the performance of the device. FIG. 10 is a schematic view showing the rotation of the vanes of the fourth embodiment of the Present Invention. The direction of rotation is shown by the curved arrows. This embodiment of the encapsulated engine 41 comprises a plurality of vanes 42 on arms 43 connected to rotating shaft 44. The vanes 42 are symmetrically shaped such that there is no force on the vane normal to the air stream. The number and configuration of the vanes may vary, and may be different from that shown in the figure.

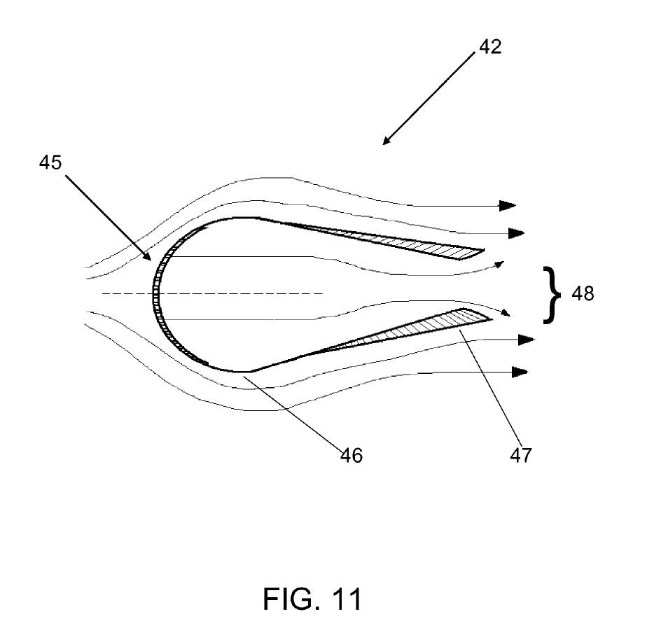

FIG. 11 shows a cross-sectional view of a single vane 42 of this embodiment. The vane comprises an aerodynamically shaped front radiometric module 45 and an aerodynamically shaped non-radiometric rear section 46. The vane itself is hollow, allowing air to pass through the radiometric module 45 into the interior of the vane 42. The rear portion 47 of section 46 is constricted to form a nozzle or air exit 48. The air exiting the interior of the vane has a higher velocity than the air entering the interior of the vane. The interior of the vane can also contain a Bernoulli tube to enhance the jet effect. The Air stream lines are shown in the figure. The axis of flow is shown as the dashed phantom line. The shape of the vane 42 is designed to reduce the friction of the air flow on every surface. The perforations of radiometric module 45 permit air to flow from the exterior of the vane into the interior. The interior of the vane is shaped so as to produce a jet effect, thereby increasing the air flow velocity and the torque applied to shaft 44.

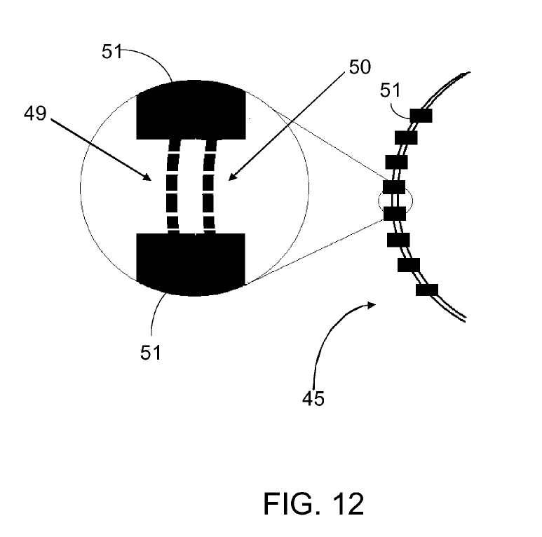

FIG. 12 shows the detail of the radiometric module with coolers for the aerodynamically shaped vane 45. The membranes 49 and 50 as well as the coolers 51 are shown in simplified form. As can be seen from the figure, the membranes are curved. The curved radiometric module can be fabricated using similar nanotechnology engineering as is used for fabricating flat membranes.

### Fifth Embodiment

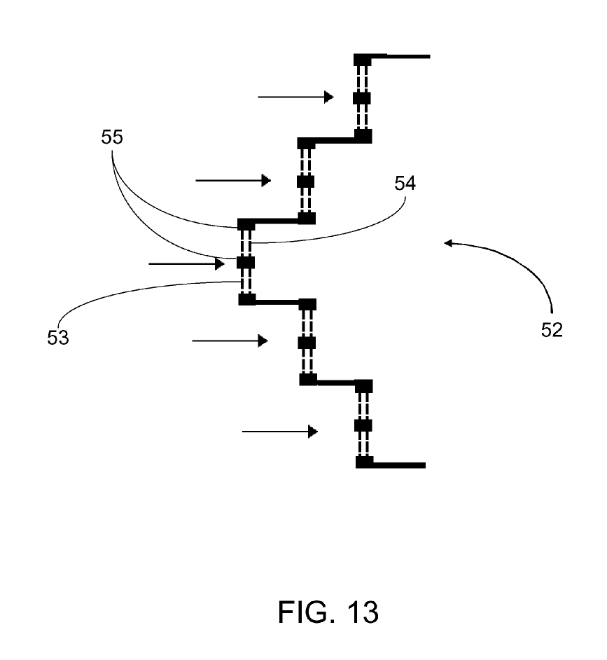

The radiometric module 45 of the fourth embodiment presents a curved surface, the shape of which is aerodynamically efficient. However, because some of the surface is not normal to the direction of motion, the radiometric thrust at any point on the surface is reduced by a factor of the cosine of the angle between the axis of flow and the normal to the surface at that point. In order to maximize the force while still maintaining aerodynamic efficiency, a step-shaped pyramidal radiometric module is used. FIG. 13 shows a cross-sectional view of a portion of the radiometric module 52. The shape of module 52 approximates the shape of module 45 of fourth embodiment, and can be substituted for module 45 in vane 42 to produce the vane of the fifth embodiment. The radiometric module 52 comprised of sub-modules each having radiometric membrane 53 and 54 oriented perpendicular to the axis of motion. The sub-modules also comprise integrated coolers 55. Both the membranes and the coolers are shown in a simplified manner.

What is claimed is:

1. A radiometric engine comprising:
a) At least one plate having two facial surfaces and at least one edge surface such that each of the two facial surfaces is maintained at a different temperature from the other and that a temperature gradient is established along an edge surface, wherein:
said plate is immersed in a gaseous medium comprised of molecules having a mean free path;
the thickness of the plate is of the order of the mean free path;
said plate comprises apertures therethrough; and,
the dimension of said apertures is of the order of the mean free path;
b) a partially or completely hollow first shaft to which each of the plates is attached;
c) a second shaft surrounded by the first shaft and about which the first shaft is free to rotate; and,
d) a vessel surrounding and containing the plate or plates, the gaseous medium, and both shafts.

2. The engine of claim 1 wherein the gaseous medium is at approximately standard temperature and pressure.

3. The engine of claim 1 wherein the gaseous medium is at approximately ambient temperature and pressure.

4. The engine of claim 1 wherein the vessel encloses and seals the gaseous medium such that no gas molecules escape from the vessel and that the number of gas molecules neither increase nor decrease.

5. The engine of claim 1 wherein the first shaft in combination with a mechanical coupling produces a rotational torque that is used to drive a mechanical device.

6. The engine of claim 1 wherein the rotational motion of the first shaft in combination with an electrical coupling produces electric current.

7. The engine of claim 1 further comprising a power source for heating one or both facial surfaces of the plate or plates.

8. The engine of claim 7 further comprising a heating element that heats the hotter facial surface and a cooling element that cools the colder facial surface.

9. The engine of claim 1 further comprising a heat pump that removes heat from the colder facial surface and recycles it to heat the hotter facial surface.

10. The engine of claim 1 wherein the plate comprises at least three layers, being a sandwich of two thermally conductive surfaces separated by an electrical and thermal insulating layer.

11. The engine of claim 10 wherein the electrical insulating layer is a gas.

12. The engine of claim 1 wherein the plate comprises at least three layers, being a sandwich of two thermally conductive facial surfaces at different temperatures, separated by a thermal insulating layer, one surface being a hotter surface and the other being a colder surface.

13. The engine of claim 12 wherein the thermal insulating layer is a gas.

14. The engine of claim 12 further comprising reinforcing members that render the plate or plates structurally stable.

15. The engine of claim 12 further comprising a power source for heating one or both surfaces of the plate.

16. The engine of claim 12 further comprising a heating element that heats the hotter facial surface and a cooling element that cools the colder facial surface.

17. The engine of claim 12 further comprising a heat pump that removes heat from the colder surface and recycles it to heat the hotter surface.

18. The engine of claim 1 wherein the facial surface of the plate or plates is essentially planar.

19. The engine of claim 1 wherein the facial surfaces of the plate or plates is curved.

20. The engine of claim 19 further comprising a curved structure or structures to which each plate is attached:
wherein the structure is hollow and has at least one exit aperture thereby permitting gas to flow therethrough; and,
wherein the combination of the plate and the curved structure produces an aerodynamically efficient element that minimizes wind resistance from the gaseous medium as said combination rotates through said medium.

21. The engine of claim 20 wherein the interior shape of the structure enhances the speed of rotation by the Bernoulli effect on the air passing therethrough.

22. The engine of claim 19 wherein the surfaces are continuously curved.

23. The engine of claim 19 wherein the surfaces are discretely curved, the surfaces being comprised of essentially planar sections.
